(19) United States
(12) Patent Application Publication
(10) Pub. No.: US 2011/0202420 A1
(43) Pub. Date: Aug. 18, 2011

(54) Innovation Brokerage

(76) Inventor: Khaled Alrasheed, Riyadh (SA)

(21) Appl. No.: 13/025,368

(22) Filed: Feb. 11, 2011

Related U.S. Application Data
(60) Provisional application No. 61/303,865, filed on Feb. 12, 2010.

(51) Int. Cl. G06Q 30/00; G06Q 90/00

(52) U.S. Cl. 705/26.2; 705/500

(57) ABSTRACT

A method for regulating exchanges between a buyer and a seller comprises the steps of: identifying a problem to be solved; submitting the problem to a broker; preparing a deal concerning the problem to be submitted to potential sellers of at least one solution to the problem; launching the deal to the potential sellers; submitting at least one solution within a particular time period by the potential sellers; filing intellectual property protection to each solution; submitting each solution from each potential seller to a selection panel; analyzing each solution and rating each solution; and communicating each rated solution to a buyer for selection.

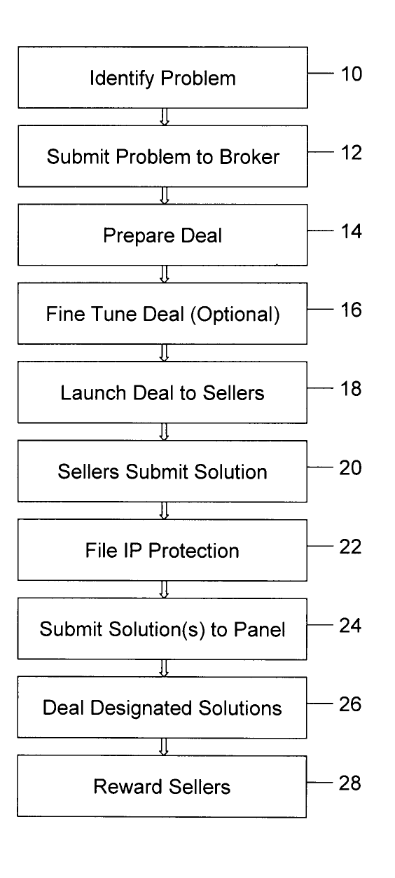

### CROSS-REFERENCE TO RELATED APPLICATION(S)

The instant application claims the benefit of provisional patent application No. 61/303,865, filed Feb. 12, 2011, entitled INNOVATION BROKERAGE, by Khaled Alrasheed.

### BACKGROUND

The present invention relates to a method of establishing an adjustable electronically controlled environment for promoting and sharing innovation. The present invention relates in particular to a method for setting up and regulating exchanges between a buyer looking for a solution to a problem and one or more sellers offering one or more solutions to this problem.

Finding a solution to a problem, in particular finding and developing a technical solution to a technical problem, can be a very time and resource consuming process. Furthermore, finding and implementing a solution may require expertise and technology that is not directly available to the person, company, institution, etc. facing the problem, so that subcontracting is often required.

Some of the issues related to subcontracting the development of a solution for a specific problem are finding the right subcontractor, keeping confidentiality of the information exchanged between the client and the subcontractor, agreeing on intellectual property ownership of the solution, determining responsibilities for the procedures related to the protection of intellectual property, sharing the benefits generated by the solution, etc.

### SUMMARY

The method of the invention allows solving at least some of the above issues by establishing, normalizing and regulating exchanges between a buyer that is looking for a solution to a problem on the one side, and one or more sellers offering one or more solutions to the problem on the other side. According to the invention, these exchanges are at least partly facilitated and managed by an innovation broker whose role will be described in more details below.

A method for regulating exchanges between a buyer and a seller comprises the steps of: identifying a problem to be solved; submitting the problem to a broker; preparing a deal concerning the problem to be submitted to potential sellers of at least one solution to the problem; launching the deal to the potential sellers; submitting at least one solution within a particular time period by the potential sellers; filing intellectual property protection to each solution; submitting each solution from each potential seller to a selection panel; analyzing each solution and rating each solution; and communicating each rated solution to a buyer for selection.

In the following description the terms buyer, seller and innovation broker can relate either to physical or moral entities. The buyer is for example, but not limited to, an individual, a group of individuals, a corporation, an administration, a research and development center, etc., or one or more representatives thereof. Similarly, the seller is for example, but not limited to, an individual, a group of individuals, a corporation, a research and development center, a research institution, etc., or one or more representatives thereof. The innovation broker is also for example, but not limited to, a single individual, a group of individuals, a corporation, an administration, an association or a foundation.

Others examples are given in the attached document (Annex 1). This is however not an exhaustive list and further types of buyers, sellers and innovation brokers are possible within the frame of the present method.

### BRIEF DESCRIPTION OF THE DRAWINGS

The FIGURE is a schematic representation of the method described hereinafter.

### DETAILED DESCRIPTION OF THE PREFERRED EMBODIMENT(S)

According to the present method, a buyer or somebody else identifies a problem and describes it, possibly with the help of an innovation broker. A price for a solution that would solve this problem is then decided. The problem remains confidential between the buyer and the innovation broker, until it is launched through a platform managed by the innovation broker. The platform is for example a website, a paper publication, a TV or radio broadcast, or any other suitable way of making the problem to be solved known to a general or targeted public. The public is preferably a predetermined set of potential sellers that are known to the innovation broker. The sellers that want to propose a solution have a limited time frame for doing so, typically by filing a description of their solution(s) with the innovation broker. Filing the solution is for example done through a secure communication on a data server of the innovation broker, or any other suitable way. Once the submission deadline is expired, the submitted solutions are preferably filed as intellectual property rights (IPRs), i.e. a patent or a NDA agreement before being analyzed and rated by judges or members of a jury, who will assess their feasibility, completeness, pertinence, etc. After solutions are rated, the following actions may occur: 1—reward winning sellers as per the predefined method for winning, 2—submit only rewarded solutions with IPR to buyer with brief summary, or 3—acknowledge sellers whom solutions were not rewarded with valid NDAs, so they could still work on their IPR, if they want to. By doing the above, GIB is not depriving any party from its rights. The rated solutions are then submitted with a brief summary to the buyer who chooses one or more solutions. The sellers that submitted the chosen solution(s) are then rewarded with a monetary amount or any other type of bounty that depends on the predefined bounty or price, preferably weighted with the rate of their solution(s). Other ways of rewarding the sellers, including the sellers whose solution(s) were not chosen, can be foreseen within the frame of the invention. The buyer is then free to implement the chosen solution(s) in order to solve his problem.

According to the present method, the innovation broker thus puts a buyer in relation with one or more sellers that could potentially solve his problem, and that the buyer possibly didn't know and/or couldn't have contacted otherwise. The geographic coverage of the launch can be in-house (internal to a company, an institution, etc.), local, regional, country-wide, international or world-wide, depending for example on the nature of the problem, for example on its technical nature, its complexity, etc., or on the desire of the buyer to find sellers (partners) in a particular geographic region or not.

The innovation broker also makes sure that the submitted solutions are analyzed and rated by competent and independent judges whose conclusions can be accepted by both parties, i.e. the buyer and the seller(s).

Furthermore, the innovation broker guarantees that at least the seller(s) whose solution(s) were chosen for implementation by the buyer will be fairly rewarded for their contribution.

The innovation broker can also participate in the problem identification and/or definition, and assist the buyer and the sellers in the various steps of the method.

At least part of the method steps are preferably implemented through one or more computer programs. In particular, the phase of problem launching and the phase of solution submission are largely computer-implemented. Furthermore, the innovation broker preferably maintains a database of potential sellers.

The steps of the method will be explained more in details below, with the help of an illustrative but in no way limitative example, illustrated by Table 1.

As illustrated in Table 1 and the FIGURE, a first step 10 of the method is the identification and/or definition of the problem to be solved. This first step essentially consists of intellectual work requiring human resources for identifying and/or clarifying the needs of the buyer. The problem that the buyer faces and wants to be solved must be defined and described in an appropriate format, for example in written form. The outcome of this first step is preferably a document describing the problem to be solved, the aims to be achieved by the solutions and possibly some indication of the preferred technical options for the solution. This first step is typically performed by the buyer or by subcontractors of the buyer, possibly with the help and assistance of the innovation broker (GIB). Other entities might nevertheless be involved in this first step, for example technical experts for identifying and defining a very specific technical problem or a part thereof.

TABLE 1

| | PROBLEMS | DEALS | PRE- | |
|---|---|---|---|---|
| PHASES | IDENTIFICATION | PREPARATION | LAUNCHING | LAUNCHING |
| INVOLVEMENTS | GIB | GIB | GIB | GIB |
| | GIB + BUYERS | GIB + BUYERS | GIB + BUYERS | |
| | OTHERS | | | |
| ACTIVITIES | OUTSOURCING | DEFINE: | SPECIAL TUNING | INFORM: |
| | | Cash and rewards | | Sellers |
| | | Judjes | | Judjes |
| | | IPR conditions | | ACTIVATE: |
| | | Set periods of next phases | | Deals to sellers |
| | | Type of deal “Global or, . . . ” | | |
| DATA | GIB | GIB | GIB | GIB |
| EXPOSED TO: | GIB + BUYERS | GIB + BUYERS | GIB + BUYERS | GIB + BUYERS |

| | INNOVATION | | | CASH& |
|---|---|---|---|---|
| PHASES | INPUT | IPR | JUDGEMENT | ROYALTIES |
| INVOLVEMENTS | SELLERS | GIB | JUDGES | GIB |
| | | GIB + LAWYERS | | GIB + BUYERS |
| | | LAWYERS | | |
| ACTIVITIES | DOWN LAOD | EXECUTE: | RATE | |
| | INNOVATION | Patenting | | |
| | Once, twice, . . . | Copy right | | |
| | | Trade marks | | |
| | | Other Types of IPR | | |
| DATA | NO ONE | IPR | Judjes | GIB + BUYERS |
| EXPOSED TO: | TOP SECURITY | Pre-designated | | |
| | | process | | |

In a variant embodiment, the problem is identified and/or defined by the innovation broker only, possibly with the help of subcontractors and/or technical experts, for example in order to find a solution to a global problem that impacts several potential buyers and thereby promoting innovation in a specific technical field. In this embodiment, the innovation broker temporarily assumes the role of the buyer.

The problem can also be identified and/or defined by any other third party that has no direct interest in buying the corresponding solution, but wishes for example to contribute to the promotion of a technical field or of a particular industry. This can be for example the case of a governmental institution, a foundation, etc. In this case also, this third party temporarily assumes the role of the buyer.

Alternatively, the problem can be defined by a group of buyers, for example but not exclusively a consortium of corporations active in a particular technical field, wishing to share technical solution(s) and the ownership of the corresponding intellectual property rights (IPRs). Predefined conditions then preferably apply regarding the IPR ownership percentage for each buyer, the freedom or limitations to use the corresponding solutions, etc.

The outcome of this first step preferably remains confidential to the innovation broker, the buyer(s) and/or other parties that were directly involved in defining and/or describing the problem, without any public disclosure.

Once the problem is identified, as shown in step 12, it is preferably submitted to the innovation broker, preferably in written format, for example by mail, courier, email, filling out of a form on a website managed by the innovation broker, or any other suitable way.

In a next step 14, the innovation broker, possibly in collaboration with the buyer, prepares the deal that will be proposed to potential sellers. Preparing the deal involves defining the rules and particulars that will build the frame to the relationship between the buyer and potential sellers. This includes for example:
defining a bounty of any type, for example but nor exclusively a price in the form of a single monetary amount and/or royalties, for a solution that would entirely and satisfactorily solve the defined problem;
appointing judges or members of a jury who will assess the validity, the feasibility, the completeness, etc., of the submitted solutions;
defining the judging criterion or criteria;
setting up the conditions for the protection and ownership of the Intellectual Property Rights (IPR) related to the submitted solutions;
elaborating a schedule for the next phases of the innovation exchange in relation with the problem;
defining the geographic extension of the deal, i.e. whether the problem will be submitted to sellers locally, regionally, country wide, worldwide (global), or according to any other configuration;
determining a deadline for the submission of the solutions by the sellers.

During this step of deal preparation, the data relative to the problem and the corresponding deal preferably remain confidential to the innovation broker and the buyer, without any public disclosure.

Once the deal is ready with its major outline defined, an optional step 16 of fine tuning can be necessary before disclosing the deal to the potential sellers. Fine tuning of the deal may for example include defining some procedural details, adapting some standard rules or conditions to local usage or legislation, etc.

The next step 18 of the present innovation brokerage method is the launching of the deal. During this step, potential sellers are informed about the deal, i.e. they have access to the description of the problem elaborated during the step of identifying and defining the problem, and to the terms of the deal, in particular to the financial and IPR-related terms.

Potential sellers are preferably known to the innovation broker before the launching of the deal. Potential sellers that are interested in participating to deals prepared by the innovation broker and providing corresponding solutions preferably signify their interest to the innovation broker, for example by registering themselves to the innovation broker. Seller registration for example happens by filling in a form on a website of the innovation broker, sending a mail, an email, a courier or a fax to the innovation broker, or by any other suitable channel. Seller registration is for example free of charge or subject to a fee. Registrations can be permanent or limited to a particular period of time, to a single deal, etc. When registering themselves, the potential sellers preferably at least indicate their geographical location and their technical field. Optional additional information may include preferred technologies, past achievements, rewards, available human resources, etc. The innovation broker then preferably owns and/or manages a database, preferably an electronic database, comprising all available information relating to the registered potential sellers.

When launching a deal, the innovation broker either informs all registered potential sellers or only targets selected potential sellers. The targeted potential sellers are for example, but not exclusively, selected on the basis of their geographical location, their technical field, their size, their past achievements, their portfolio with the particular innovation broker, etc., or a combination of any of these criteria.

In a variant embodiment, the deal is completely open to the public, i.e. even to unregistered potential seller, and is disclosed for example through a freely accessible publication on the Internet, in specialized or general press, on television and/or through any other suitable broadcasting channel.

The choice between a confidential and a publicly open launching for a specific deal may be determined for example, but not exclusively, on the basis of the nature of the problem, the geographical coverage of the deal, the number of potential sellers known to the innovation broker, etc.

Once the deal is launched, the potential sellers must respond and submit their solution(s) within the timeframe specified in the particulars of the deal, as shown in step 20. The solutions are preferably submitted according to a predefined format. The submission of the solutions is totally confidential in order to avoid destroying the potential novelty of the submitted solutions, which would compromise the possibility of obtaining valid IPR titles for these solutions. The submission of solution(s) is for example allowed at any time during the entire predefined submission period, only at a predetermined time (hour, day, etc.) at the end of the submission period, or according to any other time scheme, preferably previously determined by the innovation broker and/or the buyer. Submissions are made for example directly to the innovation broker or to any other trusted recipient that was preferably previously designated by the innovation broker and/or the buyer.

In a preferred embodiment, each seller submits one or more solutions through the Internet, for example through a dedicated and secure interface to the website of the innovation broker. The seller is for example given personal login information to the innovation broker's website where he can deposit all relevant information relating to his solution(s) in a secure data storage. Preferably, as long as the submission deadline hasn't expired, the seller can modify, delete or add information in this storage. Only the seller can access his own submitted information as long as the deadline hasn't expired.

Other submission channels are however possible within the frame of the present method. In particular, the description of the solutions can be submitted by the sellers to the innovation broker by mail, fax, courier, email or any other suitable channel.

After the expiry of the submission deadline, no further submission is accepted by the innovation broker for the corresponding deal. The related web accounts of the sellers, for example, are locked such that the submitted information can't be modified any more.

In a preferred embodiment, the expiry of the submission deadline is followed by a step 22 of provisional intellectual property protection. Preferably, all submitted solutions are collected, for example by the innovation broker and/or by one or more lawyers or other IP specialists designated by the innovation broker, and briefly analyzed under strict confidentiality in order to determine whether the submitted information should be filed as provisional patent application, design application, trademark application and/or any other appropriated type of IPR application in order to set a priority date and/or provide some form of provisional IP protection to the submitted information before their disclosure and analysis by the judges or members of the jury. The decision of taking the necessary steps to further protect the IP related to one or more of the disclosed solutions and obtain valid IP rights is then preferably left to the buyer and/or to the sellers whose solutions were not selected.

In a following step 24 of evaluation, the solutions submitted to the innovation broker are communicated to the judges or jury members designated in the phase of deal preparation. In this step, the judges analyze the submitted solutions in view of their technical expertise. They preferably assess the feasibility and the completeness of each submitted solution. Other criteria may be taken into account by the judges such as for example, but not exclusively, the originality of the solution, its implementation costs, etc. Preferably, the criteria are defined during the previous deal preparation step.

The judges rate each submitted solution with a grade expressed for example in percentage, where 100% represents a solution entirely satisfying each and every predefined criteria.

Unless otherwise specified in the particulars of the deal, the judges' evaluations are final decisions. Possible exceptions might for example be if a submitted and evaluated solution was proven to have been previously patented and/or disclosed and this hadn't been taken into account by the judge, in which case the buyer could object to the rating. Other justified objection grounds could be foreseen in the particulars of the deals, but preferably with predefined limitations in order not to jeopardize sellers from being rewarded for their contribution.

The solutions are preferably submitted anonymously to the judges. For example, the information about the author of the solution (seller) is deleted or hidden and replaced by a unique serial number in order to guarantee an objective rating of the solution.

Preferably, the judges have no interactions between each other during the evaluation phase. Possibly, the judges don't even know each other. In an embodiment, each judge is assigned one or more submitted solutions for evaluation and each submitted solution is evaluated by one judge. In another embodiment, each solution is evaluated by two or more judges and its final grade is for example an average of all received grades, or calculated according to any other predefined mathematical evaluation matrix.

The grades attributed by each judge are preferably continuously monitored over one or more deals and compared to grades attributed by other judges to the same or similar solutions. The innovation broker thereby establishes and manages a portfolio for each judge and can use this information for example in order to achieve the fairest grading possible. For example, if the grades attributed by a particular judge are always lower or higher than the grades attributed by the other judges to the same solutions, the judge can be dismissed and/or his evaluation can be corrected by a given factor.

Once the solutions have been evaluated, as shown in step 26, only rewarded solutions are disclosed to the buyer who can choose one or more of them as most appropriate for solving his problem. The solutions are for example presented to the buyer in the form of a summary only. They are preferably disclosed with their corresponding rates for facilitating the choice of the buyer.

In a last step 28 of the brokerage method, the seller or sellers whose solution(s) was (were) chosen is (are) then rewarded according to the financial conditions defined in the particulars of the corresponding deal. In a preferred embodiment, the selected seller(s) is (are) for example rewarded by a single monetary amount offered by the buyer in exchange of his/their solution(s), weighted by the grade attributed by the judges to the particular solution. In a variant embodiment, the seller(s) is (are) rewarded with predetermined royalties on the sales made by the buyer when implementing the solution, possibly weighted by the grade attributed by the judges. A combination of both a single amount and royalties is also possible within the frame of the invention.

The buyer may choose more than one solution, for example if each solution is partial and the combination of the selected solutions leads to a satisfactory complete solution. In this case, the predetermined reward is shared among the different sellers, with a repartition key based preferably on the grades attributed to each of the partial solutions.

Some more sophisticated mathematical formulas, predefined for example during the step of deal preparation or of fine tuning, can be used for determining how the seller(s) will be rewarded for his (their) solution(s). These formulas may for example take into accounts factors such as, but not limited to, the individual grades, the total number of submitted solutions and/or the number of solutions that obtained at least a given grade. It can also be decided that a predefined number of the best solutions or all solutions above a predefined grade will be rewarded according to a predefined formula.

The innovation brokerage method of the invention is preferably implemented with the help of one or more data servers for storing all relevant information relative to the registered potential sellers, the buyers, the defined problems, the deals, the submitted and later rated solutions and the conclusion of the deals. Preferably, some of the steps of the method are at least partly implemented with the help of a computer program. Said computer program for example automatically manages the launch of the deals by sending the relevant information to the selected potential sellers and/or to the judges, by allowing the sellers submitting, storing and modifying their solutions and/or by automatically blocking access to said solutions once the submission deadline expires.

The innovation broker can be active and have connections to buyers and potential sellers of various geographic origins.

According to an embodiment of the invention, several innovation brokers are located in major cities of one or more countries and manage deals having a local coverage limited to the city and its economical region. These regional innovation brokers then for example report to a national innovation broker responsible for managing deals at the level of the country, and the national innovation brokers of the different countries all report to one or more global innovation brokers that are responsible and have the capacities of managing innovation deals at a global, i.e. international or worldwide level.

In this embodiment, a buyer looking for a solution to his problem first contact the local innovation broker of his city or region and determines with his help whether the solution(s) should be sought at the local, national or global level, in which case the deal is escalated to and managed by the corresponding broker.

The innovation brokerage method is described above with one buyer and one broker managing one deal at a time. It should be understood however that the method of the invention can also be used for managing several deals in parallel by one or several innovation brokers, the corresponding problems being for example of different technical field, the deals possibly having different deadlines and/or different geographic coverage. The method of the invention thus allows for a large parallelization and scalability.

In a preferred embodiment, in order to strengthen, sustain and create a competitive environment for the participation activities, a portfolio is established and maintained for each actor of the brokerage method. However, the criteria for calculating and updating portfolios are different for each category (buyers, brokers, sellers, judges), in particular because the role of the actors of each category is different.

A buyer's portfolio for example starts with zero credit and is incremented each time the buyer buys innovation. The increment for example depends upon the price invested by the buyer. The buyer is thereby encouraged to buy innovation. The higher his portfolio is, the higher his recognition to sellers and therefore his market reputation is.

Below is a non exhaustive list of criteria that can be used for incrementing a buyer's portfolio:
For each predetermined amount of the national currency spent by the buyer for buying innovation, one national innovation unit is credited to the buyer's portfolio, thereby allowing for example the issuance of a national rank list of buyers for each country.
For a given predefined number of deals bought, one national buyer's participation unit is granted regardless of the monetary figures.
For a certain predefined number of participating sellers, one national seller's attraction unit is granted.
For a certain predefined number of deals that include a royalty, one or more national buyer's participation unit is granted regardless of the monetary figures.

These criteria may be combined and/or adapted to different type of deals and/or buyers, for example in-house, local, national or global buyers.

A broker's portfolio for example starts with zero credit and is incremented each time the broker successfully brokers innovation. The increment for example depends upon the size of the concluded deal. The broker is thereby encouraged to facilitate innovation. The higher his portfolio is, the higher is his recognition as a broker.

Below is a non exhaustive list of criteria that can be used for incrementing a brokers portfolio:
For each predetermined amount of the national currency brokered, one national innovation unit will be credited, thereby allowing for example the issuance of a national rank list of brokers for each country.
For a given predefined number of deals brokered, one national brokerage participation unit is granted regardless of the monetary figures.
For a given predefined number of participating sellers, one national seller's attraction unit is granted.
For a given predefined number of participating buyers, one national buyer's attraction unit is granted.

These criteria may be combined and/or adapted to different type of deals and/or brokers, for example in-house, local, national or global buyers.

A seller's portfolio for example starts with the highest possible membership mark in order to encourage the seller to only participate with credible new and innovated ideas, solutions and participations, and to discourage incomplete participations and reduce the costly evaluation activity.

In a variant embodiment, a defined number of seller's portfolio levels are set, and for every level, a minimum and/or a maximum number of earned units are defined to distinguish the level in innovation capability.

Below is a non exhaustive list of criteria that can be used for incrementing and/or decrementing a seller's portfolio:
For every deal, a minimum and/or a maximum number of units that can be earned when participating is defined.
For each predetermined amount of the national currency earned, thereby allowing for example the issuance of a national rank list of sellers for each country.
For a given predefined number of participations, one national seller participation unit is granted, taking into account or not the money earned.
For a given number of top winner cases, one national seller participation unit is granted, taking into account or not the money earned.
For a given number of obtained solution grades that are below a given threshold from the average, standard deviation or other grading criteria, one national seller performance unit is deducted.
For a given number of obtained solution grades that are above a given threshold from the average, standard deviation or other grading criteria, one national seller performance unit is granted.

These criteria may be combined and/or adapted to different type of deals and/or sellers, for example in-house, local, national or global buyers.

A judge's portfolio for example starts with the highest possible membership mark in order to encourage the judge to stay alert and perform his task to the best of his knowledge and capability and to make sure that the judge is evaluating with his best present status.

Below is a non exhaustive list of criteria that can be used for incrementing and/or decrementing a judge's portfolio:
For a given number of solution grades that are below or above a given threshold from the average, standard deviation or other grading criteria, one national judging performance unit is deducted.

Example,
Grading
During judging:
Every submission is graded electronically and
separately by judges
Submitters IDs are hidden
↓
For example:
“Grading for submission # 543676”
↓
Judge “A” Judge “B” Judge “C”
↓
Full grade will always be 1000 points,
as follows:
(Criteria 1 20%, Criteria 2 30%, Criteria 3 50%)
Every criteria will be graded out of 10
Hence,
criteria 1 will have 10 times 20, equals 200 points.
Simultaneously criteria 2 is 300 points,
and criteria 3 is 500.
↓
Final grading by judges:

| | Judge “A” | | Judge “B” | | Judge “C” | |
|---|---|---|---|---|---|---|
| Criteria 1 | 8 out of 10, 160 points | | 6 out of 10, 120 points | | 9 out of 10, 180 points | |
| Criteria 2 | 9 out of 10, 270 points | | 5 out of 10, 150 points | | 8 out of 10, 180 points | |
| Criteria 3 | 6 out of 10, 300 points | | 6 out of 10, 300 points | | 4 out of 10, 200 points | |
| Total | | 730 points | | 570 points | | 560 points |

↓
Final Grade:
A pre set mathematical formula for grading will be announced and entered electronically
in the system. Any or more of the following methods could be considered to fit with the
innovation deal:
Direct average calculation.
Standard deviation, to eliminate unbalanced grading.
Curve up, curve down.
Any other method.

In a variant embodiment, the submission of a first solution for a given deal for each potential seller is free of charge and evaluation of the first solution is made in a very short period of time, independently of the deal's closing deadline. The submission of each subsequent solution by the same seller, however, is preferably subject to the payment of a fee. This allows a seller from obtaining almost immediate feedback on the quality of his/her first solution and possibly improving or changing his/her concept for a second or following submission. Applying a fee for subsequent submissions however allows reducing the number of trial submissions in order to avoid unnecessary evaluation cycles.

The innovation brokerage method described herein may be presented via an innovation brokerage (IB) portal. If desired, free access may be permitted to the portal to use the innovation brokerage method. In such a scenario, no IPR will be involved and therefore no patents will be applied for. Further, in such a scenario, there would be no responsibility or involvement on the IB on the quiz, question, participants, prized, etc. For example, if a high school wants to launch a competition in mathematics, they can access the IB portal, make their own account and launch their own problem, assign their own judges, and make provisions for the students to be involved in the competition.

While the present invention has been described in the context of specific embodiments thereof. Other unforeseen alternatives, modifications, and variations may become apparent to those skilled in the art having read the foregoing description. Accordingly, it is intended to embrace those alternatives, modifications, and variations as fall within the broad scope of the appended claims.

### ANNEX 1

### Innovation Buyers

Government Agencies:

Seeking ideas, solutions and suggestions for a break through advancement via massive domain of minds with deferent views and mentalities is a very effective innovation outsourcing on one hand, and a true sharing of national responsibility that will lead to successful planning and decision making on the other hand.

“GIB” can professionally assist in sculpturing the general sector demands for innovation in any field of development.”

Foundations:

Allowing people with all their diversity to participate in the thinking process to optimize benefits in outputs from what is available in hand, is a true sharing of responsibility, and will help foundations ingrain an image for themselves and put in practice the common phrase “We do care”.

“GIB” could certainly help in identifying what kind of innovation should be demanded to fulfill the mission.

Research Centers:

Missing links in science discoveries are very mysterious and difficult to solve. It requires full depth work and a memory recall for all what have been done to analyze each and every thinking process in their own merit and find out what links were missing in the first place.

Searching solutions for missing links could be carried out through “GIB” by tailoring special innovation deals for every innovation buyer from this sector.

Business Entities:

Grapping a competitive edge in congested markets can be quickly achieved by putting the hand on innovative ideas that will sustain any business floreshment and success and own all its IPR.

“GIB” could certainly help in identifying and orchestrating what kind of innovation needed to fulfill missions of prosperity.

Innovation Buyers

Consultancy & Design Houses:

Studies & projects conducted in those lands of organizations require brilliant ideas to base their studies on. Yet. these entities rely only on their staff to suggest such ideas, because they are intentionally forced to forget that the outside large domain of minds are way far better for innovative ideas. Simply, because of the high cost involved in seeking innovation outside their domain on one hand, and the over sensitivity in exposing their projects on the other hand. These kinds of houses will not hesitate to be innovation buyers specially if they are assured that the seeking cost is very low compared to the quality of submitted innovation.

Opportunity Seekers:

Opportunities are rarely found, even though they do exist mysteriously around the corner. Their keys, however, are inside the minds of too many innovative people who do not have the ability or the know how to formulate them. Such fact, has kept very unique opportunities sadly imprisoned in many minds.

Through “GIB” innovated evenly scaled desire process, such rare opportunities could be intentionally released from their imprisonment to entrepreneurs who can effectively utilize them?

What can we provide an innovation buyer?

The decision to sell innovation is located between the need and the temptation. We in “GIB” will define in cooperation with innovation buyers their position and quest for innovation and put it in certain scale in order to make innovation sellers ready to sell. We invented the process to create art optimum satisfaction for every innovation deal. This is only one essential part of what we can provide any innovation buyer in addition to our unique innovated methods in providing the following:
Reach thousands of adequate brains.
Pay Only for quality suitable bright ideas and solutions.
Maximize your innovation cost/benefit ratio.

Own all answers IPR for your paid submitted innovation deals.
Be there first, as you incrementally gain pertinent knowledge domain for your specialty.

Innovation Sellers

No individual, institute, company or even a country are reluctant to evoke innovation if the return in terms of balanced benefits is equal or more than the cost of innovation. If your mind accepts such an idea, then innovation can be extracted from all kinds of thinking. Those below are only examples of innovation sellers.

Research Centers:

Specialty in most fields of science is paramountly vital to the industry. The knowledge discoveries in such domains are considered of high secrecy and value, and therefore, the reluctance to share such knowledge becomes very high. Simply, because the big money invested had brought them to a situation where they cannot invest any more even though the happy ending is under their feet. As a result, humanity—unfortunately and unintentionally—are deprived from science positive output because of such predominant practices.

However, if a credible managed mechanism insures that a genuine environment and circumstances are present, then many research centers could share their scientific Secrets with an equal or higher level institute or organization if the rewards and royalties are up to the quality of shared information.

Consultancy & Design Houses:

Consultancy and design houses invest a lot of time in preparing their bids to clients. They create a number of innovative ideas and submit them free of charge as sketches and perspectives. However, there is no pay back for it unless their proposal wins the approval. This process does not optimize time cost and IPR for these types of houses and certainly does not escalate innovation for clients as will. Therefore, our methods could certainly inspire these houses to submit their upmost innovation to clients with no risk in loosing their IPR, and their clients will not be paying extra financial obligation.

Innovation Brokers

Problems are created mostly from either interference or contradiction of interactive elements. Such elements, sculpture a background environment that contain key information leads to problem solving if tackled innovatively. These environments have very far apart extremes in terms of size and impact for every single problem.

Therefore, the adequate domain of minds that have the highest probability of solving a problem is that domain of minds involved in the background.

We in “GIB” designed our system to adopt different innovation buying entities by emphasizing the importance of managing their own innovation needs under our direct management and consultancy.

Global Innovation Broker “GIB”:

All global issues that all nations are faced with, such as pollution, water shortage and earth rising temperature. are no longer a total responsibility of government agencies. Simply, because those issues are a direct result of human living practices on one hand, and the negative effect on all aspects of life on the other hand. Therefore, it is a shared responsibility of governments and people to exchange benefits in order to find safe innovative exits from such disasters. However, solutions and remedies for such disasters require a massive scale global launching platform for innovation.

“GIB” is systematically designed and structured to handle such issues.

National Innovation Broker “NIB”:

Every nation has its own culture that portrays itself to its own creators “people”.

Therefore, the people of every nation or country are the most advocate candidates that could identify their existing or future problems in every aspect of life.

Once they identify any problem, a national innovation broker could carry out a national or a national/global quest for innovation to provide probable solutions for any addressed problem.

“NIB” is created to profoundly tackle such national issues.

What is claimed is:

1. A method for regulating exchanges between a buyer and a seller comprising the steps of:
identifying a problem to be solved;
submitting the problem to a broker;
preparing a deal concerning said problem to be submitted to potential sellers of at least one solution to said problem;
launching the deal to said potential sellers;
submitting at least one solution within a particular time period by said potential sellers;
filing intellectual property protection to each said solution;
submitting each said solution from each said potential seller to a selection panel;
analyzing each said solution and rating each said solution; and
communicating each said rated solution to a buyer for selection.

2. The method of claim 1, further comprising rewarding a seller of a selected solution.

3. The method of claim 1, further comprising optionally fine tuning said deal prior to said launching step.

4. The method of claim 1, wherein said launching step comprises transmitting said deal to said potential sellers on a website controlled by said broker.

5. The method of claim 1, wherein said launching step comprises transmitting said deal to said potential sellers by one of a television broadcast, a radio broadcast, and a written paper document.

6. The method of claim 1, wherein said launching step comprises transmitting said deal in-house.

7. The method of claim 1, wherein said launching step comprises transmitting said deal to potential sellers located locally or regionally.

8. The method of claim 1, wherein said launching step comprises transmitting said deal on a world wide basis.

9. The method of claim 1, further comprising maintaining a database of potential sellers and said launching step comprising selecting potential sellers from said database.

10. The method of claim 1, wherein said submitting step comprises submitting each said solution to at least one independent judge.

11. The method of claim 1, wherein said identifying step comprises identifying the problem that the buyer faces and wants to be solved and preparing a document containing the problem to be solved, the aims to be achieved by the solutions, and optionally an indication of preferred technical options.

12. The method of claim 11, wherein said identifying step is performed by the broker.

13. The method of claim 11, wherein said identifying step is performed by a third party that has no direct interest in buying the solution.

14. The method of claim 11, wherein said identifying step is performed by a group of buyers.

15. The method of claim 1, wherein said deal preparing step comprises defining rules and particulars that build a frame to a relationship between a buyer and potential sellers.

16. The method of claim 15, wherein said rule defining step comprises defining a bounty for a solution, appointing judges or members of a jury who will assess the submitted solutions, defining judging criterion or criteria, setting up conditions for protection and ownership of intellectual property rights related to submitted solutions, elaborating a schedule for next phases of said exchange, defining geographic extent of the deal, and determining a deadline for submission of the solutions by the sellers.

17. The method of claim 1, wherein said launching step comprises informing potential sellers about the deal.

18. The method of claim 1, wherein said submitting step comprises providing personal login information to a broker's website to each said seller and storing said submitted solution.

19. The method of claim 18, wherein said seller may modify, delete or add information to the solution in storage.

20. The method of claim 1, wherein said submitting step to said selection panel is performed so that said selection panel does not know the identity of the seller connected with each said solution.

21. A method for regulating exchanges between a buyer and a seller comprising the steps of:
identifying a problem to be solved;
submitting the problem to a broker;
preparing a deal concerning said problem to be submitted to potential sellers of at least one solution to said problem;
launching the deal to said potential sellers;
submitting at least one solution within a particular time period by said potential sellers;
submitting each said solution from each said potential seller to a selection panel;
analyzing each said solution and rating each said solution; and
communicating each said rated solution to a buyer for selection.
